(19) United States
(12) Patent Application Publication
(10) Pub. No.: US 2004/0065183 A1
(43) Pub. Date: Apr. 8, 2004

(54) Disk cutter

(75) Inventor: Tanehiko Asada, Iwata-gun (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: TENRYU SEIKYO KABUSHIKI KAISHA, Shizuoka (JP)

(21) Appl. No.: 10/402,974

(22) Filed: Apr. 1, 2003

(30) Foreign Application Priority Data
Oct. 3, 2002 (JP) 2002-290608

(51) Int. Cl. B27B 33/02

(52) U.S. Cl. 83/838; 83/849

(57) ABSTRACT

Disclosed herein is a disk cutter including an annular disk-shaped base adapted to be driven about an axis of rotation, a plurality of tip supports formed along the outer circumference of the base integrally therewith so that a gullet is defined between adjacent ones of the tip supports, and a plurality of cutting tip inserts respectively fixed to the tip supports. Each of the cutting tip inserts has a pair of rakes inclined from the opposite side surfaces of each tip insert to the center of the thickness of each tip insert so as to define a first V-shaped groove, and a pair of flanks inclined from the opposite side surfaces of each tip insert to the center of the thickness of each tip insert so as to define a second V-shaped groove. The pair of rakes are formed in symmetry with respect to the center of the thickness of each tip insert, and the pair of flanks are also formed in symmetry with respect to the center of the thickness of each tip insert.

### BACKGROUND OF THE INVENTION

1. Field of the Invention

The present invention relates generally to a disk cutter, and more particularly to a disk cutter or circular saw suitable for cutting of a board (decorative laminate) having a surface to which a hard decorative film is fixed.

2. Description of the Related Art

A disk cutter or tip saw including a base disk having a plurality of tip supports arranged along the outer circumference and a plurality of hardened cutting tip inserts (cutter inserts) respectively fixed to the tip supports by brazing or the like is frequently used for board cutting or the like. The tip supports are spaced at given intervals in the circumferential direction of the base disk or annular disk-shaped base, and a gullet (chip space) is defined between adjacent ones of the tip supports. Each tip support has a recess, and each cutting tip insert is fixed in the recess of the corresponding tip support by brazing or the like. The base disk has a first mounting hole at its central portion, and a boss portion of a collar is inserted through the first mounting hole. The boss portion of the collar is formed with a second mounting hole, and a rotating shaft of a rotary tool is inserted through the second mounting hole. The disk cutter is mounted to the rotary tool by fastening the base disk through the collar to the rotating shaft with a bolt.

Examples of the cutting tip insert include a plain tip insert having a cutting edge whose height is uniform, an inclined tip insert having a rake inclined at a given transverse rake angle and a flank inclined at a given transverse clearance angle, and a tip insert having a triangular or trapezoidal cutting edge. Of these kinds of tip inserts, the inclined tip insert is generally used for cutting of a decorative laminate.

In a disk cutter having a plurality of inclined tip inserts fixed to the outer circumference of a base disk and alternately arranged so that the positive inclination of the rake and the flank and the negative inclination of the rake and the flank are alternately arranged, the cutting edge of each tip insert is set on either side of the base disk, so that the amount of cutting by each tip insert is large and the shock to the cut surface is therefore large. Further, the knife marks generated on the cut surface become coarse. Accordingly, in cutting a board (decorative laminate) having a surface to which a hard decorative film is fixed, there arises a problem of edge chipping or cracking on the cut surface of the decorative film. Further, the cut surface becomes rough.

### SUMMARY OF THE INVENTION

It is therefore an object of the present invention to provide a disk cutter which can cut a board (decorative laminate) having a surface to which a hard decorative film is fixed without the edge chipping or cracking on the cut surface of the decorative film.

In accordance with an aspect of the present invention, there is provided a disk cutter including an annular disk-shaped base adapted to be driven about an axis of rotation; a plurality of tip supports formed along the outer circumference of the base integrally therewith so that a gullet is defined between adjacent ones of the tip supports; and a plurality of cutting tip inserts respectively fixed to the tip supports; each of the cutting tip inserts having a pair of rakes inclined from the opposite side surfaces of each tip insert to the center of the thickness of each tip insert so as to define a first V-shaped groove, and a pair of flanks inclined from the opposite side surfaces of each tip insert to the center of the thickness of each tip insert so as to define a second V-shaped groove.

Preferably, the first V-shaped groove is formed with a groove extending along the center of the thickness of each tip insert in a radial direction of the base. The pair of rakes are formed in symmetry with respect to the center of the thickness of each tip insert, and the pair of flanks are formed in symmetry with respect to the center of the thickness of each tip insert. The angle of inclination of each of the rakes is set in the range of 15 to 40°, preferably 22 to 25°, and the angle of the inclination of each of the flanks is set in the range of 15 to 40°, preferably 22 to 25°.

In accordance with another aspect of the present invention, there is provided a disk cutter including an annular disk-shaped base adapted to be driven about an axis of rotation; a plurality of tip supports formed along the outer circumference of the base integrally therewith so that a gullet is defined between adjacent ones of the tip supports; a plurality of first cutting tip inserts fixed to a given number of ones of the tip supports and intermittently arranged along the outer circumference of the base; and a plurality of second cutting tip inserts fixed to the remaining tip supports; each of the first cutting tip inserts being selected from the group consisting of a plain tip insert and a trapezoidal tip insert; each of the second cutting tip inserts having a pair of rakes inclined from the opposite side surfaces of each second cutting tip insert to the center of the thickness of each second cutting tip insert so as to define a first V-shaped groove, and a pair of flanks inclined from the opposite side surfaces of each second cutting tip insert to the center of the thickness of each second cutting tip insert so as to define a second V-shaped groove.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a partially sectional side view of a part of a disk cutter according to a first preferred embodiment of the present invention;

FIG. 2 is an enlarged view of an essential part of FIG. 1;

FIG. 3 is a view taken in the direction shown by an arrow III in FIG. 2;

FIG. 4 is a view taken in the direction shown by an arrow IV in FIG. 2;

FIG. 5 is a partially sectional, enlarged side view of an essential part of a disk cutter according to a second preferred embodiment of the present invention;

FIG. 6 is a plan view similar to FIG. 4, showing an essential part of a third preferred embodiment of the present invention;

FIG. 7 is a plan view similar to FIG. 4, showing an essential part of a fourth preferred embodiment of the present invention;

FIG. 8 is a sectional view for illustrating a manner of brazing a tip insert to a base disk;

FIG. 9 is a partially cutaway, elevational view showing a fifth preferred embodiment of the present invention; and

FIG. 10 is a partially cutaway, elevational view showing a sixth preferred embodiment of the present invention.

### DETAILED DESCRIPTION OF THE PREFERRED EMBODIMENTS

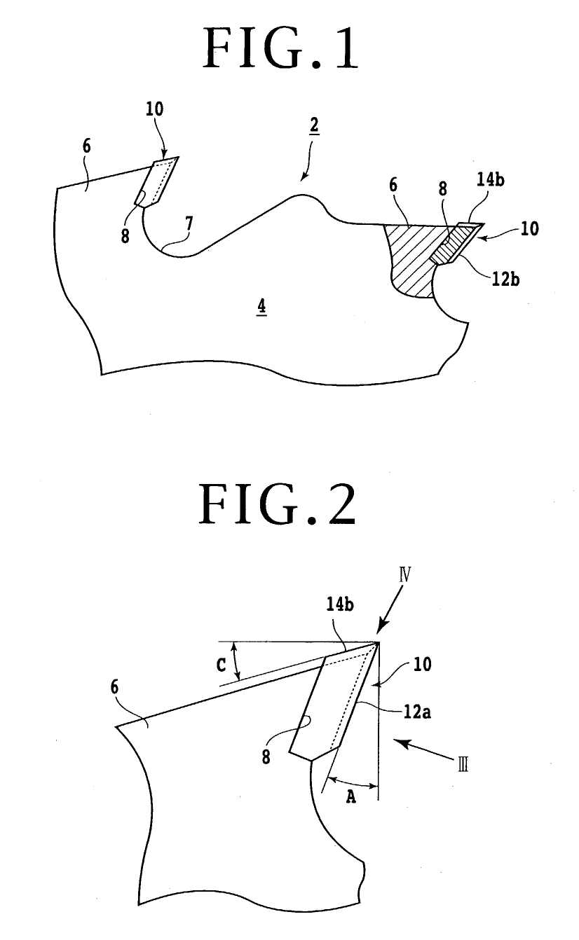

Referring to FIG. 1, there is shown a partially sectional side view of a part of a disk cutter 2 according to a first preferred embodiment of the present invention. The disk cutter 2 is formed suitably for cutting of a board (decorative laminate) having a surface to which a hard decorative film is fixed. In this preferred embodiment, the disk cutter 2 includes an annular disk-shaped base (base disk) 4 having a thickness of about 1.2 mm and a plurality of (e.g., 24) saw-toothed tip supports 6 formed along the outer circumference of the base disk 4 at equal intervals. A gullet (chip space) 7 is defined between adjacent ones of the tip supports 6. The base disk 4 is formed of steel such as JIS SKS51 (alloy tool steel), JIS SK5 (carbon tool steel), or JIS SK6 (carbon tool steel).

As best shown in FIG. 2, each tip support 6 is formed with a recess 8 for receiving a hardened cutting tip insert (cutter insert) 10. The cutting tip insert 10 is formed of a greatly hard material such as cemented carbide as specified by JIS K10 or K20. The cutting tip insert 10 is set in the recess 8 of each tip support 6, and is brazed by silver solder or the like.

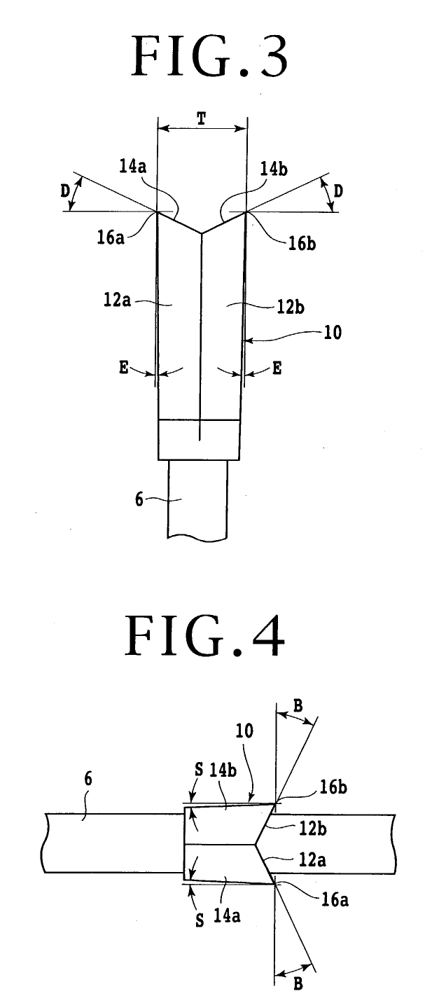

As shown in FIGS. 2 to 4, each cutting tip insert 10 has a pair of rakes 12a and 12b and a pair of flanks 14a and 14b. The thickness of the tip insert 10 is about 1.8 mm. The rake angle A of each of the rakes 12a and 12b is about 20°. The clearance angle C of each of the flanks 14a and 14b is about 15°. The side clearance angle S of each side surface of the tip insert 10 is about 3°. The centripetal angle E of each side surface of the tip insert 10 is about 1°. The rakes 12a and 12b are inclined from the opposite side surfaces of the tip insert 10 to the center of the thickness of the tip insert 10 so as to define a V-shaped groove having a uniform depth over the length of each rake. Similarly, the flanks 14a and 14b are inclined from the opposite side surfaces of the tip insert 10 to the center of the thickness of the tip insert 10 so as to define a V-shaped groove having a uniform depth over the length of each flank.

In other words, the rakes 12a and 12b are negatively inclined from the opposite side surfaces of the tip insert 10 to the center of the thickness of the tip insert 10 in a direction opposite to the rotational direction of the disk cutter 2 as shown in FIG. 4. Further, the flanks 14a and 14b are negatively inclined from the opposite side surfaces of the tip insert 10 to the center of the thickness of the tip insert 10 in a direction toward the center of rotation of the disk cutter 2. The rakes 12a and 12b are formed in symmetry with respect to the center of the thickness of the tip insert 10, and the flanks 14a and 14b are also formed in symmetry with respect to the center of the thickness of the tip insert 10. The angle of inclination (transverse rake angle) B of each of the rakes 12a and 12b in the transverse direction of the tip insert 10 is set in the range of 15 to 40°, and the angle of inclination (transverse clearance angle) D of each of the flanks 14a and 14b in the transverse direction of the tip insert 10 is also set in the range of 15 to 40°.

In the case of cutting a board having a surface to which a hard decorative film such as a melamine resin film is fixed, both the transverse rake angle B and the transverse clearance angle D are preferably set in the range of 22 to 25°. The rakes 12a and 12b are formed simultaneously with sintering of the tip insert 10 in a die. The flanks 14a and 14b are formed by fixing the tip insert 10 to each tip support 6 of the base disk 4 and thereafter grinding the tip insert 10 with a grinding wheel of a grinder. The rakes 12a and 12b may be formed by sintering the tip insert 10 and next grinding it before fixing it to the base disk 4.

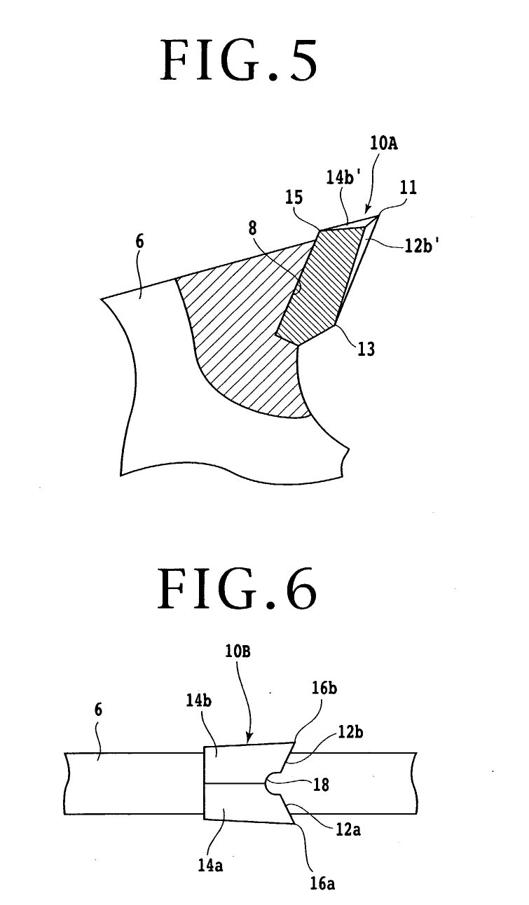

FIG. 5 is a partially sectional, enlarged side view of an essential part of a second preferred embodiment of the present invention. Reference numeral 10A denotes a cutting tip insert according to the second preferred embodiment. The cutting tip insert 10A has a pair of rakes 12a′ and 12b′ (only the rake 12b′ being shown) and a pair of flanks 14a′ and 14b′ (only the flank 14b′ being shown). The rakes 12a′ and 12b′ are inclined from the opposite side surfaces of the tip insert 10A to the center of the thickness of the tip insert 10A so as to define a V-shaped groove having a nonuniform depth gradually decreasing from a front edge 11 to a lower edge 13 of the tip insert 10A. That is, each of the rakes 12a′ and 12b′ has a narrow triangular shape as viewed in side elevation. Similarly, the flanks 14a′ and 14b′ are inclined from the opposite side surfaces of the tip insert 10A to the center of the thickness of the tip insert 10A so as to define a V-shaped groove having a nonuniform depth gradually decreasing from the front edge 11 to a rear edge 15 of the tip insert 10A. That is, each of the flanks 14a′ and 14b′ has a narrow triangular shape as viewed in side elevation. The other configuration of this preferred embodiment is similar to that of the first preferred embodiment.

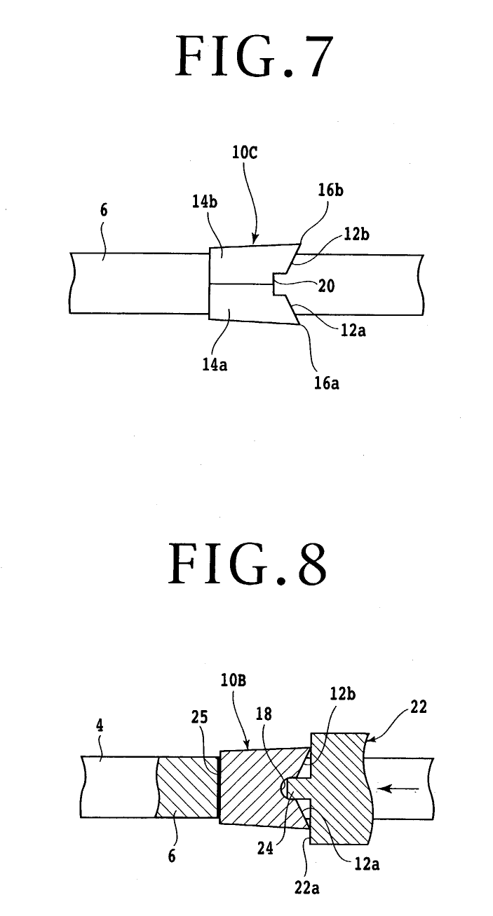

FIG. 6 is a partially cutaway, plan view of a third preferred embodiment of the present invention. Reference numeral 10B denotes a cutting tip insert according to the third preferred embodiment. The cutting tip insert 10B has a pair of rakes 12a and 12b and a pair of flanks 14a and 14b similar to those of the first preferred embodiment. The cutting tip insert 10B further has a groove 18 having a semicircular shape as viewed in plan. The groove 18 extends along the boundary between the rakes 12a and 12b in the vertical direction (the radial direction of the disk cutter 2), that is, along the center of the thickness of the tip insert 10B. The groove 18 is formed simultaneously with formation of the rakes 12a and 12b in sintering the tip insert 10 in a die. FIG. 7 shows a cutting tip insert 10C according to a fourth preferred embodiment of the present invention. In the fourth preferred embodiment, a groove 20 having a rectangular shape as viewed in plan is formed in place of the semicircular groove 18 shown in FIG. 6.

The groove 18 or 20 functions as a positioning groove in brazing the tip insert 10B or 10C to each tip insert 6 of the base disk 4. FIG. 8 illustrates a manner of positioning the tip insert 10B having the groove 18 to the tip support 6 by using rectangular jig 22. The rectangular jig 22 has a pressure surface 22a and a positioning projection 24 formed on the pressure surface 22a along the center of the thickness of the jig 22. The positioning projection 24 extends in the vertical direction (the radial direction of the disk cutter 2). The positioning projection 24 is adapted to be fitted with the groove 18 of the tip insert 10B. The tip insert 10B is positioned to the tip support 6 in the following manner. First, the groove 18 of the tip insert 10B is fitted to the projection 24 of the jig 22, and a pair of cutting edges 16a and 16b of the rakes 12a and 12b of the tip insert 10B are brought into abutment against the pressure surface 22a of the jig 22. In this condition, the tip insert 10B is set in the recess 8 of the tip support 6 with a melted brazing material 25 interposed therebetween by applying a pressure to the jig 22. By hardening the brazing material 25, the tip insert 10B is fixed to the tip support 6. According to the third or fourth preferred embodiment, the cutting tip insert 10B or 10C can be brazed to the tip support 6 with a high accuracy at the transversely central position of the base disk 4, so that the cutting edges 16a and 16b formed at the front end of the tip insert 10B or 10C can be positioned with a high accuracy.

According to each of the above preferred embodiments, each of the cutting tip inserts 10, 10A, 10B, and 10C has the cutting edges 16a and 16b formed between the rakes 12a and 12b and the flanks 14a and 14b, respectively. Each of the cutting edges 16a and 16b is formed with the transverse rake angle B in a horizontal plane and with the transverse clearance angle D in a vertical plane. The cutting edges 16a and 16b are adapted to simultaneously come into contact with a workpiece and then cut the workpiece. Accordingly, the amount of cutting by each cutting tip insert is reduced as compared with that in the prior art, so that the shock to the cut surface of the workpiece is reduced. Further, the knife marks generated on the cut surface become dense, so that the edge chipping or cracking on the cut surface can be suppressed to thereby obtain a smooth cut surface. In particular, a board having a surface to which a hard decorative film such as a melamine resin film is fixed can be smoothly cut.

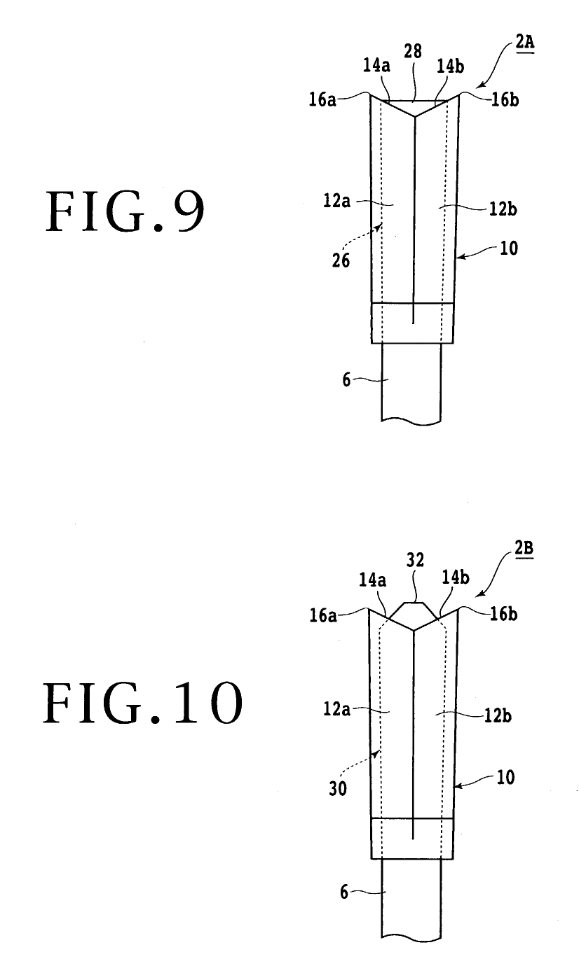

FIG. 9 is a partially cutaway, elevational view of a fifth preferred embodiment of the present invention. Reference numeral 2A denotes a disk cutter according to the fifth preferred embodiment. The disk cutter 2A includes a plurality of plain tip inserts 26 fixed to some of the tip supports 6 and a plurality of cutting tip inserts 10 fixed to the remaining tip supports 6. The tip inserts 10 and the plain tip inserts 26 are arranged so that each plain tip insert 26 is positioned for every several ones of the tip inserts 10. That is, the plain tip inserts 26 are arranged intermittently. Each plain tip insert 26 has a cutting edge 28 slightly lower in level than each of the cutting edges 16a and 16b of each tip insert 10. By fixing these two kinds of tip inserts 10 and 26 to the tip supports 6, the cutting ridge of the tip inserts 10 can be shortened to thereby further reduce the shock to the cut surface of the workpiece. As a result, the edge chipping or cracking on the cut surface can be further suppressed.

FIG. 10 is a partially cutaway, elevational view of a sixth preferred embodiment of the present invention. Reference numeral 2B denotes a disk cutter according to the sixth preferred embodiment. The disk cutter 2B includes a plurality of trapezoidal tip inserts 30 fixed to some of the tip supports 6 and a plurality of cutting tip inserts 10 fixed to the remaining tip inserts 6. The tip inserts 10 and the trapezoidal tip inserts 30 are arranged so that each trapezoidal tip insert 30 is positioned for every several ones of the tip inserts 10. That is, the trapezoidal tip inserts 30 are arranged intermittently. Each trapezoidal tip insert 30 has a cutting edge 32 slightly higher in level than each of the cutting edges 16a and 16b of each tip insert 10. This preferred embodiment can exhibit an effect similar to that of the fifth preferred embodiment shown in FIG. 9. That is, the cutting ridge of the tip inserts 10 can be shortened to thereby further reduce the shock to the cut surface of the workpiece. As a result, the edge chipping or cracking on the cut surface can be further suppressed.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A disk cutter comprising:
an annular disk-shaped base adapted to be driven about an axis of rotation;
a plurality of tip supports formed along the outer circumference of said base integrally therewith so that a gullet is defined between adjacent ones of said tip supports; and
a plurality of cutting tip inserts respectively fixed to said tip supports;
each of said cutting tip inserts having a pair of rakes inclined from the opposite side surfaces of each tip insert to the center of the thickness of each tip insert so as to define a first V-shaped groove, and a pair of flanks inclined from the opposite side surfaces of each tip insert to the center of the thickness of each tip insert so as to define a second V-shaped groove.

2. A disk cutter according to claim 1, wherein said first V-shaped groove is formed with a groove extending along the center of the thickness of each tip insert in a radial direction of said base.

3. A disk cutter according to claim 1, wherein said pair of rakes are formed in symmetry with respect to the center of the thickness of each tip insert, and said pair of flanks are formed in symmetry with respect to the center of the thickness of each tip insert.

4. A disk cutter according to claim 3, wherein the angle of inclination of each of said rakes is set in the range of 15 to 40°, and the angle of the inclination of each of said flanks is set in the range of 15 to 40°.

5. A disk cutter comprising:
an annular disk-shaped base adapted to be driven about an axis of rotation;
a plurality of tip supports formed along the outer circumference of said base integrally therewith so that a gullet is defined between adjacent ones of said tip supports;
a plurality of first cutting tip inserts fixed to a given number of ones of said tip supports and intermittently arranged along the outer circumference of said base; and
a plurality of second cutting tip inserts fixed to the remaining tip supports;
each of said first cutting tip inserts being selected from the group consisting of a plain tip insert and a trapezoidal tip insert;
each of said second cutting tip inserts having a pair of rakes inclined from the opposite side surfaces of each second cutting tip insert to the center of the thickness of each second cutting tip insert so as to define a first V-shaped groove, and a pair of flanks inclined from the opposite side surfaces of each second cutting tip insert to the center of the thickness of each second cutting tip insert so as to define a second V-shaped groove.

6. A disk cutter according to claim 5, wherein said first V-shaped groove is formed with a groove extending along the center of the thickness of each second cutting tip insert in a radial direction of said base.

7. A disk cutter according to claim 5, wherein said pair of rakes are formed in symmetry with respect to the center of the thickness of each second cutting tip insert, and said pair of flanks are formed in symmetry with respect to the center of the thickness of each second cutting tip insert.

8. A disk cutter according to claim 7, wherein the angle of inclination of each of said rakes is set in the range of 15 to 40°, and the angle of the inclination of each of said flanks is set in the range of 15 to 40°.
